(19) United States
(12) Patent Application Publication
(10) Pub. No.: US 2005/0279069 A1
(43) Pub. Date: Dec. 22, 2005

(54) Systems, device, and methods for efficient vegetation maintenance at multiple infrastructure sites

(75) Inventors: Robert Novembri, Novato, CA (US); James A. Garcia, Newark, CA (US); Edward Krufka, Land O Lakes, FL (US)

Correspondence Address: AKERMAN SENTERFITT, P.O. BOX 3188, WEST PALM BEACH, FL, 33402-3188, US

(73) Assignees: CN UTILITY CONSULTING, LLC, Novato, CA (US); ENPORION INC., Tampa, FL (US); VIRYANET, INC., Southborough, MA (US)

(21) Appl. No.: 11/154,299

(22) Filed: Jun. 16, 2005

Related U.S. Application Data
(60) Provisional application No. 60/580,027, filed on Jun. 16, 2004.

(51) Int. Cl. A01D 46/00

(52) U.S. Cl. 56/13.1

(57) ABSTRACT

A network-based system for coordinating over a data communications network a plurality of vegetation maintenance events at a plurality of sites is provided. The network-based system includes a computing system in communication with the data communications network for receiving site-specific vegetation indicators for different sites, generating a forecast of vegetation conditions for at least one of the sites based upon the site-specific vegetation indicators, and generating a schedule for performing future vegetation maintenance events within a predefined time period based on the forecast of needed vegetation maintenance. The network-based system further includes one or more data communications devices in communication with the data communications network. A communications device in communication with the data communications network provides site-specific vegetation indicators to the computing system, and/or receives a post-event vegetation maintenance report from the computing system.

### CROSS-REFERENCE TO RELATED APPLICATIONS

This application claims the priority benefit of U.S. Provisional Patent Application 60/580,027, filed Jun. 16, 2004.

### FIELD OF THE INVENTION

The present invention is related to the field of forestry and vegetation management, and more particularly, to the allocation and coordination of personnel, equipment, and other scarce resources for maintaining the condition of vegetation at critical infrastructure sites.

### BACKGROUND OF THE INVENTION

Electric utilities must typically devote considerable resources each year to maintaining trees and other vegetation in and around easements and rights-of-way where power lines and other critical infrastructure are located. Failure to maintain the vegetation at such sites can cause serious problems. Overgrowth of vegetation, for example, can contact transmission and distribution power lines, causing unnecessary power outages, fires, and even threats to public safety. Other types of infrastructure can similarly be adversely affected if the growth of trees and other vegetation is left unchecked for any significant period of time. Less immediate but no less serious in effect, such overgrowth can generally create a public nuisance for the surrounding community. Public utilities that provide water, phone services, and cable and broadband connections, for example, share a similar concern for controlling vegetation in and around sites in which water pipes, communication lines, and other infrastructure are located.

Apart from the need to maintain vegetation at sites on which public utility infrastructure is located, there is a similar need to maintain vegetation in various urban environments as well as other settings. For example, trees and shrubbery must typically be pruned and maintained to prevent obstruction of city or county traffic signs. Aesthetic and environmental considerations at different sites provide additional rationales for maintaining vegetation in urban environments and other settings.

Notwithstanding the recognized need for and long-term benefits of maintaining vegetation at critical infrastructure sites, in urban environments, and various other settings, the task can be a complicated and costly one for public utilities, governmental agencies, and private entities. It is estimated, for example, that electric utilities alone in the United States spend more than two billion dollars annually for such maintenance. A large part of the burden stems from the sheer number and wide dispersion of sites where utility infrastructure and facilities are often located. Moreover, vegetation, by its very nature, must be maintained on a regular basis. The same challenges that typically confront public utilities are similarly faced by governmental organizations and private entities that are tasked with providing on-going vegetation maintenance.

One approach is for the public utility or other entity to contract out the maintenance of vegetation at various sites to private contractors that specialize in such activity. Even so, the public utility or entity that contracts out the task of maintaining vegetation still incurs the expense of administering these contracts and monitoring their performance. Moreover, it is the public utility or entity that bears the ultimate responsibility for making sure that the vegetation at these sites is properly maintained since it is the utility or entity that suffers if poor maintenance interrupts a critical service or causes a more serious long-term problem.

Despite the urgent need and attendant expense for maintaining vegetation at numerous and dispersed sites, current utility vegetation management (UVM) programs implemented by most utilities, as well as those pursued by other entities, are largely unchanged from those pursued in years past. In large measure this is the result of a failure to bring new technologies to bear on the problem. Thus, there is yet lacking in the art an effective and efficient system or technique for maintaining vegetation at a large number of disparate sites on which public utility facilities and infrastructure are located.

### SUMMARY OF THE INVENTION

The present invention provides a network-based system and a computer-based system, as well as related method, for efficiently and effectively handling the various tasks necessary for maintaining vegetation at a plurality of different sites, including sites on which critical public utility infrastructure is located. The invention can be used for determining resource requirements and for optimally scheduling and allocating resources needed to meet the objective of maintaining vegetation in a desired condition at these sites. For example, the invention can be used for determining which sites must receive attention and when, as well as what types of equipment, fertilizer, or other resource are needed to perform a designated vegetation maintenance event at a designated site.

The invention, moreover, can be used to assign in-house or under-contract work crews to the task of maintaining the vegetation at these sites. The invention also can monitor and track the performance of vegetation maintenance events. Such monitoring and tracking can include, for example, undertaking post-performance audits, managing contracts, and performing various related tasks such as invoicing and billing.

Additionally, the invention can be used for centrally managing the various tasks associated with vegetation maintenance. For example, the invention can provide effective communications between a centrally located manager and one or more maintenance crews in the field. Accordingly, the manager can more efficiently direct crews to specific sites and assign needed vegetation maintenance tasks to the crews. The same communication capabilities can be used by a utility or other entity to communicate to property owners when and where the vegetation maintenance is to occur, thus affording property owners advance notice of scheduled work.

According to one particular embodiment of the invention, a network-based system for efficiently managing vegetation maintenance can include a computing system communicatively linked to one or more communication devices via a data communications network such as a wireless local area network (WLAN) or the Internet. The computing system can operate by (a) receiving a plurality of site-specific vegetation indicators for the plurality of sites; (b) generating a forecast of needed vegetation maintenance for the plurality of sites based upon the plurality of site-specific vegetation indicators; (c) generating a schedule for performing future vegetation maintenance events within a predefined time period based on the forecast of needed vegetation maintenance; and (d) generating post-event vegetation maintenance reports based upon performance indicia received after performances of vegetation maintenance events at the plurality of sites.

The one or more communication devices can each be linked to one another as well as to the computing system via the data communications network. The one or more communication devices can operate by (a) providing the site-specific vegetation indicators to the at least one computing system; and (b) receiving a post-event vegetation maintenance report from the at least one computing system.

Another embodiment of the invention is a computer-based system for managing vegetation maintenance at a plurality of sites. The computer-based system can include a memory for storing a plurality of site-specific vegetation indicators, the vegetation indicators indicating vegetation conditions at a plurality of predetermined sites. The computer-based system also can include a forecasting module for generating a forecast of needed vegetation maintenance for the plurality of sites based upon the plurality of site-specific vegetation indicators. Additionally, the computer-based system can include a scheduling module for generating a schedule for performing future vegetation maintenance events within a predefined time period based on the forecast of needed vegetation maintenance.

Still another embodiment of the invention is a method for performing vegetation maintenance at a plurality of sites. The method can obtaining site-specific vegetation maintenance indicia and scheduling a plurality of vegetation maintenance events to occur within a predetermined time period at a plurality of predetermined sites. Additionally, the method can include performing a plurality of vegetation maintenance events in accordance with the scheduling of the plurality of vegetation maintenance events. The method further can include auditing the performing of the plurality of vegetation maintenance events to determine a measure of performance achievement.

Yet another embodiment of the invention is a machine-readable medium. The machine-readable medium can comprise computer instructions for storing in a database a plurality of site-specific vegetation indicators for a plurality of sites. The machine-readable medium also can comprise one or more computer instructions for generating a forecast of needed vegetation maintenance for the plurality of sites based upon the plurality of site-specific vegetation indicators. Additionally, the machine-readable medium can comprise one or more computer instructions for generating a schedule for performing future vegetation maintenance events within a predefined time period based on the forecast of needed vegetation maintenance. According to still another embodiment, the machine-readable medium can further comprise one or more computer instructions for generating post-event vegetation maintenance reports based upon performance indicia received after performances of vegetation maintenance events at the plurality of sites.

### BRIEF DESCRIPTION OF THE DRAWINGS

There are shown in the drawings, embodiments which are presently preferred. It is to be understood, however, that the invention is not limited to the precise arrangements and instrumentalities shown.

FIG. 1 is a schematic diagram of a network-based system for coordinating vegetation maintenance events at a plurality of sites, according to one embodiment of the invention.

FIGS. 2a and 2b are schematic diagrams of network-based systems for managing vegetation maintenance at a plurality of sites, according to other embodiments of the invention.

FIG. 3 is a schematic diagram of a computer-based system for managing vegetation maintenance at a plurality of sites, according to another embodiment of the invention.

FIG. 4 is a schematic diagram of a computer-based system for managing vegetation maintenance at a plurality of sites, according to yet another embodiment of the invention.

FIG. 5 is a schematic diagram of a computer-based system for managing vegetation maintenance at a plurality of sites, according to still another embodiment of the invention.

FIG. 6 is a flowchart of the exemplary steps of a method for coordinating vegetation maintenance events at a plurality of sites, according to another embodiment of the invention.

### DETAILED DESCRIPTION OF PREFERRED EMBODIMENTS

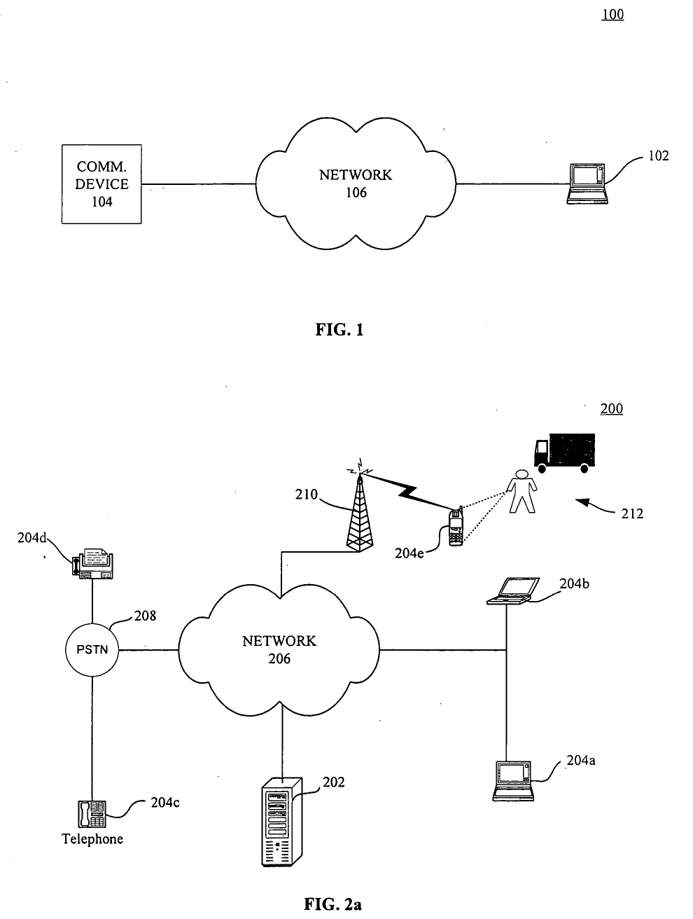

Referring initially to FIG. 1, a network-based system 100 for coordinating vegetation maintenance events at multiple sites, according to the invention, illustratively includes a computing system 102 and a communications device 104 in communication with the computing system. As illustrated, both the computing system 102 and the communications device 104 are communicatively linked with one another through their respective links to a data communications network 106. The system 100, as explained herein, schedules and coordinates a plurality of vegetation maintenance events at a plurality of sites via the data communications network 106.

As used herein, vegetation refers to trees, plants, grass, or other shrubbery. A vegetation maintenance event denotes the planting, pruning, cutting, removing, or similar activity relating to the control, care, and general upkeep of vegetation. The system 100 for scheduling and coordinating vegetation maintenance events is described here in the context of maintaining vegetation in and around rights-of-way and easements used by electrical, telephone, gas, and other public utilities for the placement of necessary infrastructure, such as power lines, underground cables, substations and a host of similar infrastructure edifices and equipment. It will be readily apparent from the description, however, that the system 100 is applicable to urban forestry management and similar, related fields of endeavor.

Efficient maintenance of vegetation at a multiplicity of disparate sites depends critically on the scheduling, allocation, coordination, and monitoring of different types of resources, which in turn depend critically on the efficient collection, collation, and analysis of different data indicating the condition of the vegetation at the various sites. In order to achieve efficiency, data in the form of site-specific vegetation indicators can be coded for conveyance over the data communications network 106 from the communications device 104 to the computing system 102, as explained more particularly below. In turn, instructions for efficiently coordinating utility resources needed to perform vegetation maintenance events at the sites can be conveyed via the data communications network 106 to the communications device 104 from the computing system 102, as also explained more particularly below.

As will be readily understood by one of ordinary skill in the art, the data communications network 106 can be a wide-area network, local area network such as a LAN, or the Internet. The communications device 104 can be a wireless device, such as a cellular or mobile phone. Alternatively, the communications device 104 can be a device such as a telephone or fax connected via a public switched telephone network (PSTN) or voice over Internet protocol (VoIP) network to the data communication network 106. According to still another embodiment, the communications device 104 can be a computer, such as a personal computer or laptop computer, having a capability to exchange data via the data communications network 106.

According to one embodiment, the computing system 102 receives various site-specific vegetation indicators corresponding to various different sites. The vegetation indicators can be received directly with a conventional input/output (I/O) device, such as a keyboard, and/or via a communications link to the data communications network 106. The computing system 102 generates a forecast of vegetation conditions for at least one of the plurality of sites based upon the site-specific vegetation indicators. The computing system 102 additionally generates a schedule for performing future vegetation maintenance events within a predefined time period based on the forecast of needed vegetation maintenance. Optionally, the computing system 102 can also generate one or more post-event vegetation maintenance reports based upon performance indicia received after performances of vegetation maintenance events at the plurality of sites.

Although only one computing system 102 and only one communications device 104 are shown, it is to be understood that the network-based system 100 can include more than one such computing system, as well as more than one communications device. It is to be further understood that combinations of various types of communications devices can be utilized. At least one data communication device 104 is in communication with the data communications network 106. The at least one data communications device 104 performs at least one of two functions: providing site-specific vegetation indicators to the at least one computing system and/or receiving a post-event vegetation maintenance report from the computing system.

The computing system 102, more particularly, can comprise one or more general-purpose computers. Alternatively, or in addition thereto, the computing system 102 can comprise one or more application-specific computers. The computing system 102 can comprise one or more input/output (I/O) devices connected to the one or more computers. Additionally, the computing system 102 can comprise one or more databases contained in or otherwise connected to the one or more computers.

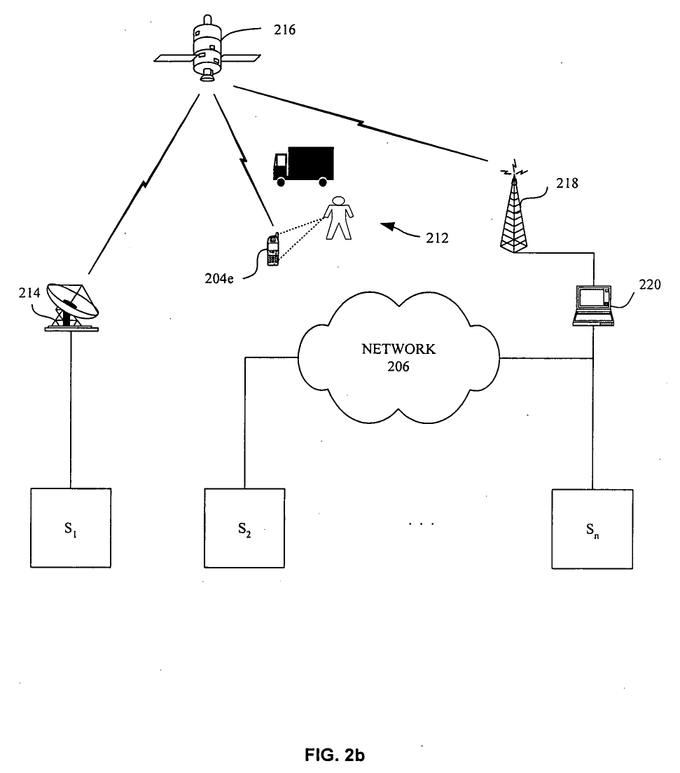

Referring now to FIG. 2a, in a network-based system 200 for coordinating multiple vegetation maintenance events at different sites according to another particular embodiment, the computing system 202 illustratively comprises a server in communication with multiple communication devices. The communication devices illustratively include a general-purpose computer 204a, a laptop computer 204b, a telephone 204c, a fax 204d, and a mobile phone 204e.

Each of the communications devices communicates with the computing system 202 via the data communications network 206. The general-purpose computer 204a connects via direct link to the data communications network, as does the laptop computer 204b. The phone 204c and fax 204d each connect via a PSTN switching circuit 208, while the mobile phone 204e connects via a wireless communications antenna 210 that is communicatively linked to the data communications network 206. As will be readily appreciated by one of ordinary skill in the art, other combinations with more or fewer of these communication devices can be used to implement the network-based system 200 of the invention. Likewise, other types of communications devices can be used to implement the network-based system 200.

As noted above and described more fully below, the various communications devices can provide site-specific vegetation indicators to the computing system 202 and/or receive scheduling or performance instructions, as well as post-event vegetation maintenance reports, from the computing system. The computing system 202 performs the critical functions of analysis and coordination that are the object of the communications carried over the data communications network 206 between the computing system and communications devices 204a-e. Coordination is effected, for example, by the conveyance of work assignments to a company or contract maintenance crew 212 via over the data communications network 206 and mobile phone 204e.

Referring additionally now to FIG. 2b, the communications devices of a network-based system 201 can additionally, or alternatively, comprise one or more site sensors, S₁, S₂, . . . , Sₙ. The site sensors, S₁, S₂, . . ., Sₙ, each provide vegetation indicators, the vegetation indicators indicating conditions related to the vegetation at a particular site. A site sensor, S₁, according to the invention, can provide a visual observation or other measurement of vegetation conditions at the specific site. One or more such site sensors S₁, S₂, . . . , Sₙ can be positioned at the various sites where vegetation conditions are to be monitored. A site sensor, Sᵢ, for example, can be a camera that records or directly transmits observations of vegetation conditions at the site. Alternatively, the sensor, Sᵢ, can record or directly transmit readings of conditions that affect vegetation such as wind velocities, temperatures, and/or rainfall at different times at a particular site. According to still other embodiments, the sensor, Sᵢ, can be inserted into the ground at the site to record or directly transmit readings of soil nutrients, soil moisture, or similar soil-based measurements pertinent to assessing vegetation conditions at the site.

As further illustrated, a sensor, S₁, can communicatively link to a wireless transmitter 214, such as a satellite link that transmits via a satellite 216 over a wireless channel. One or more of the readings or measurements of sensed vegetation conditions at a site is transmitted over the channel as illustrated. The transmitted reading, or readings, can be received at a receiver 218 and conveyed to a central computing system 220. One or more sensors, S₂, can convey the same or similar type readings or measurements to the central computing system 220 via the data communications network 206, as already described. Moreover, one or more sensors, Sₙ, as further illustrated, can convey a reading or measurement of a vegetation condition directly to the central computing system 220.

The satellite 216 can additionally, or alternatively, serve as a global positioning satellite that is part of global positioning system (GPS) for locating sites. The GPS can be used, for example, by centralized managers and/or maintenance crews 212 to locate various sites. Alternatively, the satellite can be part of a geographic information system (GIS) which provides spatial information, such as maps, that are captured, stored, analyzed, displayed and retrieved by the GIS users. This information can similarly be used by centralized managers and/or maintenance crews 212 in monitoring and managing vegetation conditions at different, remotely-located sites. As already noted, a maintenance crew 212 can communicate via the communications networks 206, and accordingly, maps and other pertinent GIS information can be conveyed via the network to handheld devices capable of rendering a visual display of the maps and/or other information to be used on-site by the maintenance crew.

Operatively, according to one embodiment, the computing system 202 receives and stores the site-specific vegetation indicators for the various sites. The computing system 202 also generates a forecast of needed vegetation maintenance for the various sites. The forecast can be based upon the site-specific vegetation indicators. Additionally, the computing system 202 generates a schedule for performing future vegetation maintenance events within a predefined time period. The schedule can be based on the forecast of needed vegetation maintenance. The computing system 202 further generates post-event vegetation maintenance reports based upon performance indicia received after performances of vegetation maintenance events at the plurality of sites.

According to one embodiment, the site-specific vegetation indicators include past performance data representing past performances of vegetation maintenance events. The forecast of needed vegetation maintenance generated by the computing system 202 generates the forecast based on the stored past performance data. Past performance data can include, for example, work previously needed at a particular site and/or equipment needed in the past for performing the needed work.

Alternatively or additionally, the site-specific vegetation indicators can include past expenditure data representing past expenditures for performing vegetation maintenance events. The computer system 202, therefore, also can generate the forecast of needed vegetation maintenance based on past expenditures needed to maintain vegetation at each site.

Moreover, the vegetation indicators, alternatively or additionally, can include site-anomaly data. As used herein, site-anomaly data is data that is indicative of vegetation anomalies for at least one of the plurality of sites. Such anomalies can include reports on an inordinate number of problems, such as power outages, having occurred within a specified period at a particular site, where the nature of the problems suggests that they were likely due to overgrowth or other vegetation anomalies. Such anomalies also can be efficiently reported via the mobile phone 204e or similar such handheld device carried by the company or contract maintenance crew 212. Accordingly, the computing system 202 can generate the forecast of needed vegetation maintenance based on reported site-anomaly data.

According to yet another embodiment, the site-specific vegetation indicators alternatively, or additionally, include a site-specific vegetation inventory for each of the plurality of sites. A vegetation inventory can record the number of trees and plants at a site. Additionally, the vegetation inventory can record the particular specie of each of the various trees and plants at a particular site. The vegetation inventory also can provide information on the distance of trees and shrubs from key elements of the public utility infrastructure at the particular site. These indicia can be used by the computing system 202 for generating the forecast of needed vegetation maintenance.

An additional site attribute, recorded either as part of the vegetation inventory or separately, is a record of property ownership regarding property adjacent to a particular site. These records can be important, for example, if a dispute arises as to responsibility for properly maintaining vegetation on property adjacent to the site or for dealing with problems at a site stemming from the vegetation on property adjacent the site (e.g., falling branches or overgrowth of trees on the adjacent property).

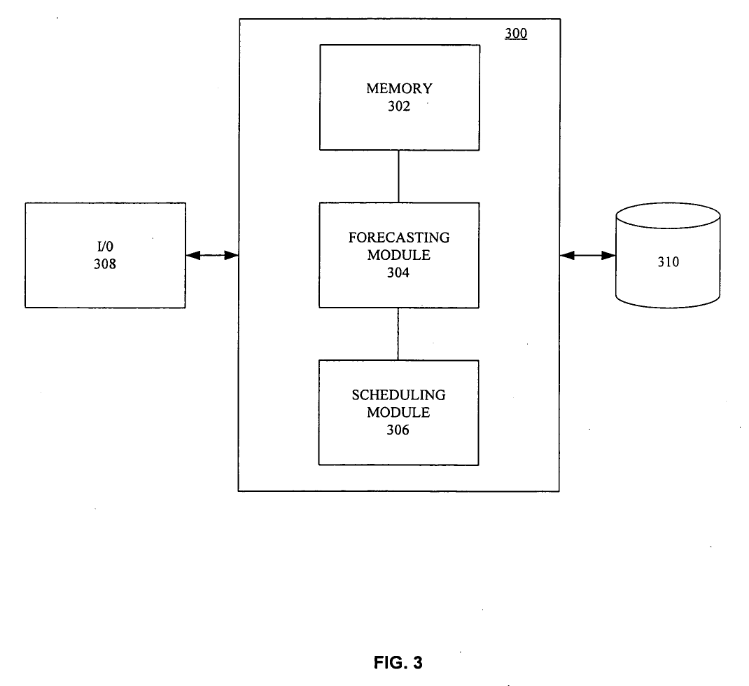

Referring now to FIG. 3, a computer-based system 300 for managing vegetation maintenance at different sites, according to another embodiment of the invention, is illustrated. The system 300 illustratively includes a memory 302, a forecasting module 304 in communication with the memory, and a scheduling module 306 communicatively linked to the forecasting module. The forecasting module 304 and the scheduling module 306 can each be implemented in one or more dedicated hardwired circuits for performing the operations described herein. Alternatively, one or both of the modules can be implemented as machine-readable code configured to run on a general-purpose or application-specific computing device, the code containing computer instructions for performing the same operations. According to still another embodiment, one or both of the modules comprises a combination of dedicated circuitry and machine-readable code.

Operatively, the memory 302 stores a plurality of site-specific vegetation indicators. The site-specific vegetation indicators indicate the condition of vegetation at different sites on which are located utility facilities or other utility infrastructure. More particularly, the vegetation indicators can indicate the number as well as the type or specie of trees, plants, and other vegetation units at the each particular site where public utility infrastructure is located. Additionally, the vegetation indicators can further indicate where in relation to the public utility assets, facilities, or other infrastructure at a site each of the vegetation units at that same site are located.

The forecasting module 304 generates a forecast of vegetation conditions expected at a future point in time. Thus, the forecasting module 304, according to one embodiment, forecasts projected growth of various vegetation units at the different sites. The forecasting module 304 can use actual or estimated growth rates for the various vegetation units to forecast growth and, thus ultimately, the future condition of vegetation at the various sites.

The growth rates used by the forecasting module 304 for forecasting growth, according to another embodiment of the invention, are factor-adjusted growth rates. More particularly, the growth rate employed to forecast growth of a particular vegetation unit at a site can be adjusted on the basis of so-called vegetation competition; that is, based upon other vegetation in the vicinity of the particular vegetation unit where the other vegetation is likely to be “in competition” with the particular vegetation unit for growth-inducing elements such as soil nutrients and ground water.

Still another factor by which the factor-adjusted growth rates can be adjusted is the micro climate for a given site. As will be readily understood by one of ordinary skill in the art, a micro climate is a localized climate at a relatively limited-sized area. Micro climates can vary from site to site since each micro climate is affected by various site-specific factors such as tree cover, or lack thereof, exposure to winds, and various other localized climatic conditions.

Yet another factor that can be advantageously used to adjust the growth rates used by the forecasting module 304 is a profile of past climate conditions, defining a climatic profile, in and around a particular site. The profile provides for a mechanism for adjusting growth rates so as to take into account past conditions such as recent droughts, prolonged periods of rain, and storm aftermaths.

According to still another embodiment, the forecasting module 304 has the capability to predict the amount of time that a vegetation unit at a particular site will meet a predefined tolerance. A tolerance can be uniquely associated with a particular utility asset, reflecting the fact that different assets can require different tolerances or buffers. For example, an asset such as a 440 Kv transmission line requires a greater tolerance or buffer than does a 15 Kv transmission line. Thus the forecasting module 304, according to this embodiment, enables a system user to readily ascertain an answer to a question such as: “what is the date that the oak tree located at lot X-15 will be within a predefined tolerance?”

According to still another embodiment, the forecast module 304 further includes a tolerance override. The tolerance override provides a mechanism for ignoring a predefined tolerance or otherwise indicating whether a competing governmental or utility-specific policy takes precedence over the predefined tolerance. For example, some states that normally require an eighteen inch tolerance for vegetation adjacent to electric power lines nonetheless follow the so-called “Major Woody” exception that excludes certain classes of trees from the requirement. Thus, the tolerance override enables the forecasting module 304 to provide forecasts according to predefined tolerances while also indicating those special circumstances where other policy objectives take precedence over predefined tolerances.

The scheduling module 306 generates a schedule for performing the needed vegetation maintenance events within a predefined time period based on the forecast of needed vegetation maintenance events. As part of the scheduling performed, the scheduling module 306 determines which sites are to be attended to and when, as well as what resources will be needed for performing designated vegetation maintenance activities at each site. Thus, the scheduling module 306 can determine how many man-hours need to be allocated to a site for performing a specific vegetation maintenance event. Accordingly, the size of the maintenance crew that needs to be dispatched in order for the maintenance to be performed within an allotted time can be determined by the scheduling module 306.

Additionally, the scheduling module 306 can determine the specific equipment that is to be allocated in order to perform the maintenance within the allotted time given the size of the maintenance crew available. The scheduling module 306 further can determine which additional resources should be allocated to specific sites as well as the quantities to be used of each. For example, the scheduling module 306 can determine which fertilizers, in what quantities, as well as which herbicides and/or insecticides and the quantities of each, which are to be allocated to which specific sites. The allocation of resources, moreover, can be optimized by configuring the scheduling module 306 to perform one or more mathematical programming techniques, such as the SIMPLEX or other known linear programming technique, for the optimal allocation of such resources. The same or other known techniques can be incorporated into the operation of the scheduling module so that resources can be allocated to minimize or otherwise manage costs associated with maintaining vegetation at various remotely-located sites.

According to one particular embodiment, the scheduling module 306 prioritizes multiple performances of vegetation maintenance so as to prioritize performances according to a predefined set of criteria. The criteria, for example, can require that infrastructure deemed most critical to continuous operation of the public utility at a given location be maintained to an extent and according to a schedule designed to minimize the likelihood of an interruption of the service.

Optionally, the computer-based system 300 can also include one or more input/output (I/O) devices 308 by which data can be provided to the system in machine-readable form, and conversely, data in human-readable form can be received from the system. Additionally, the computer-based system optionally includes a separate memory 310 in which one or more databases containing the site-specific vegetation indicators and/or other data are stored for a desired period of time.

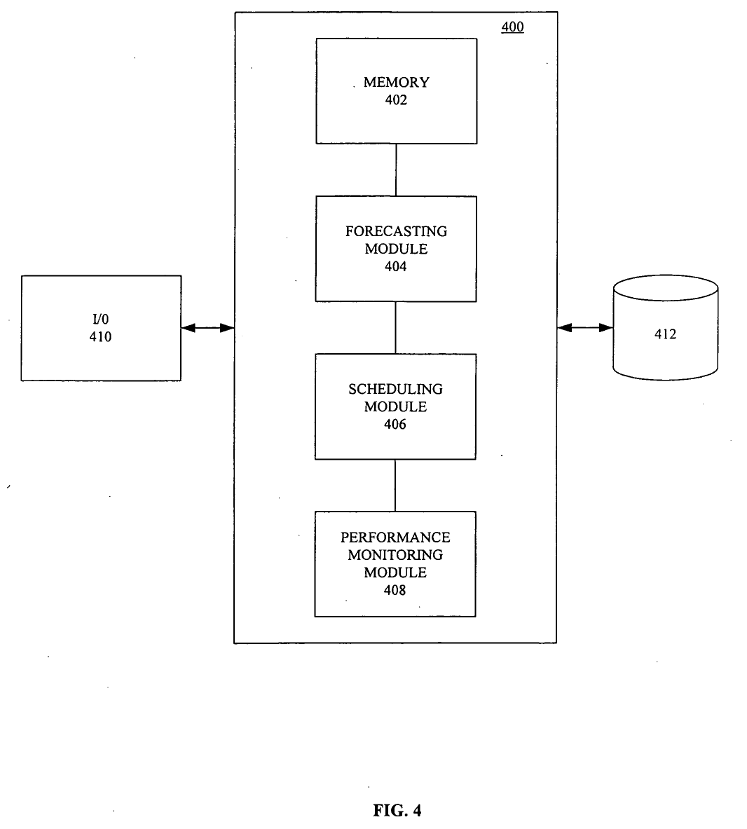

A computer-based system 400 for managing vegetation maintenance at different sites according to still another embodiment of the invention is illustrated in FIG. 4. The computer-based system 400 illustratively includes a memory 402, a forecasting module 404, and a scheduling module 406 as already described. Additionally, however, the computer-based system 400 further includes a performance monitoring module 408. Like the other modules, the performance monitoring module 408 can be implemented in dedicated circuitry, machine-readable code, or a combination of hardwired circuitry and machine-readable code.

Operatively, the performance monitoring module 408 generates post-event vegetation maintenance reports. The reports can be based upon performance indicia received after vegetation maintenance events are performed. According to one embodiment, such reports are generated following the performance of one or more vegetation maintenance events performed in accordance with the schedule generated by the scheduling module 406.

Optionally, the computer-based system 400 can further include one or more input/output (I/O) devices 410, as already described. Separately, or in addition to the I/O device 410, the computer-based system 400 can include separate memory 412 as also described already.

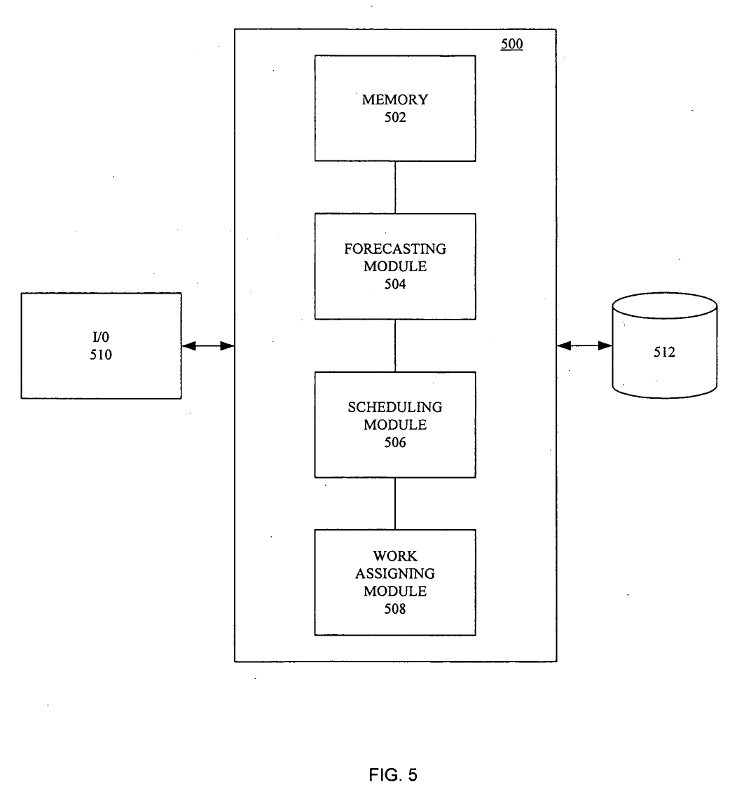

Yet another embodiment of a computer-based system 500 for managing vegetation maintenance at different sites is illustrated in FIG. 5. The computer-based system 500 illustratively includes a memory 502, a forecasting module 504, and a scheduling module 506 as already described, but further includes a work assigning module 508. The work assigning module 508, like each of the other modules, also can be implemented in hardwired circuitry and/or machine-readable code configured to run on a general-purpose or application-specific computer.

Operatively, the work assigning module 508 generates a set of one or more work assignments for performing vegetation maintenance events at one or more locations. The work assignments generated by the work assigning module 508, moreover, can be based upon the schedule generated by the scheduling module 506 and/or a plurality of site-specific vegetation indicators. The computer-based system 500 optionally includes one or more of the already-described input/output (I/O) devices 510 and/or a separate memory 512.

According to one embodiment, the work assigning module 508 generates a work assignment for a particular site based on one or more of the following: the type of work to be performed at the site; the type of equipment needed to perform the work assignment; and/or a predetermined time period in which the work assignment is to be performed. According to another embodiment the work assigning module 508 receives work performance data based upon performances of the work assignments and generates post-performance evaluations of the work performed. According to still another embodiment, the work assigning module 508 generates invoices and associated billing records based on post-performance evaluations of the work. According to yet anther embodiment, the work assigning module 508 generates an updatable list of contractors for performing future work assignments. The list of contractors, moreover, can be updated intermittently based upon at least one the post-performance evaluations.

According to still other embodiments, a computing system can include a module for electronically notifying owners of property adjacent to property on which infrastructure is located of the need to perform a maintenance event that may affect the adjacent property. According to one particular embodiment, the module can send a notice via a data communication network of the type already described. If the maintenance event is likely to require going onto the adjacent property, the module can be further configured to request permission from the owner or owners of the adjacent property via the data communications network. According to yet other embodiments, a computing system can include a module configured to handle the payment of bills associated with the maintenance of vegetation, such as those incurred through contracting with independent maintenance crews described above. Similarly, the computing system can include a module configured to receive payments for vegetation maintenance performed on behalf of other owners of property at which such maintenance is performed.

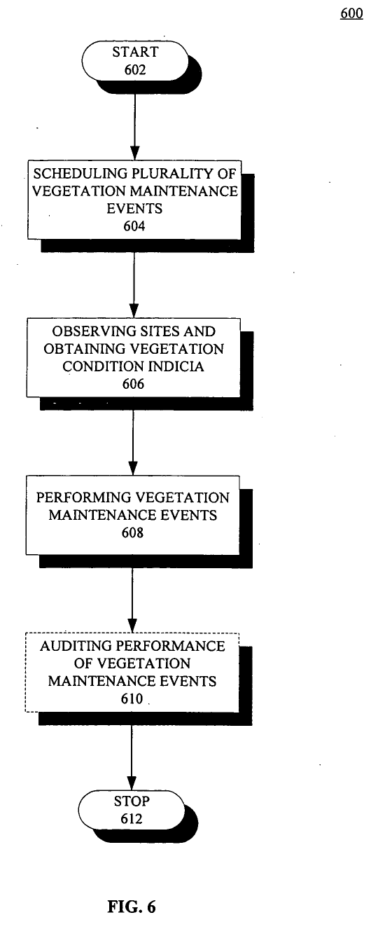

FIG. 6 provides a flowchart of the exemplary steps of a method 600 for handling vegetation maintenance at a multiplicity of different sites on which a public utility's facilities or other infrastructure are located. The method 600 illustratively begins at step 602. The method 600 illustratively continues at step 604 with the scheduling of a plurality of vegetation maintenance events that are to occur within a predetermined time period at a plurality of predetermined sites. At step 606, the method 600 illustratively entails inspecting or otherwise monitoring at least one of the plurality of predetermined sites to determine site-specific vegetation maintenance indicia. One or more vegetation maintenance events in accordance with the schedule are illustratively undertaken at step 608. An auditing of the performance of one or more vegetation maintenance events is optionally undertaken at step 610 in order to determine a measure of performance achievement. The method illustratively concludes at step 612.

Although various embodiments of the invention have been described in the context of vegetation maintenance at sites where public utility infrastructure is located, from these descriptions it will be readily apparent to one of ordinary skill in the art that the invention has broader applicability. The invention can also be utilized in various other settings, including urban environments in which vegetation maintenance is often needed. The invention can be utilized for forestry and vegetation management by a host of governmental organizations and private entities tasked with maintaining large and/or numerous tracks of land requiring forestry or vegetation maintenance.

Various aspects of the present invention, as noted throughout, can be realized in hardware, software, or a combination of hardware and software. The present invention can be realized in a centralized fashion in one computer system, or in a distributed fashion where different elements are spread across several interconnected computing systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This present invention can be embodied in other forms without departing from the spirit or essential attributes thereof. Accordingly, reference should be made to the following claims, rather than to the foregoing specification, as indicating the scope of the present invention.

1. A network-based system for coordinating over a data communications network a plurality of vegetation maintenance events at a plurality of sites, the network-based system comprising:
a computing system in communication with the data communications network for
(a) receiving a plurality of site-specific vegetation indicators for the plurality of sites,
(b) generating a forecast of vegetation conditions for at least one of the plurality of sites based upon the plurality of site-specific vegetation indicators, and
(c) generating a schedule for performing future vegetation maintenance events within a predefined time period based on the forecast of needed vegetation maintenance;
and
at least one data communications device in communication with the data communications network for performing at least one of
(a) providing the site-specific vegetation indicators to the at least one computing system, and
(b) receiving a post-event vegetation maintenance report from the at least one computing system.

2. The network-based system as defined in claim 1, wherein the computing system additionally generates post-event vegetation maintenance reports based upon performance indicia received after performances of vegetation maintenance events at the plurality of sites

3. The network-based system as defined in claim 1, wherein the forecast generated by the computing system comprises a forecast of a time when at least one unit of vegetation is within a predefined tolerance for a corresponding unit of infrastructure.

4. The network-based system as defined in claim 1, wherein the forecast generated by the computing system is based upon at least one factor-adjusted growth rate for at least one vegetation unit, the growth rate being adjustable based upon at least one of a vegetation competition factor, a climatic profile factor, and a micro climate factor.

5. The network-based system as defined in claim 1, wherein the site-specific vegetation indicators include past performance data representing past performances of vegetation maintenance events, and wherein the computing system generates the forecast of needed vegetation maintenance based on the stored past performance data.

6. The network-based system as defined in claim 1, wherein the site-specific vegetation indicators include past expenditure data representing past expenditures for performing vegetation maintenance events, and wherein the computing system generates the forecast of needed vegetation maintenance based on the past expenditure data.

7. The network-based system as defined in claim 1, wherein the site-specific vegetation indicators include site-anomaly data indicative of vegetation anomalies for at least one of the plurality of sites, and wherein the computing system generates the forecast of needed vegetation maintenance based on the site-anomaly data.

8. The network-based system as defined in claim 1, the site-specific vegetation indicators include a site-specific vegetation inventory for each of the plurality of sites and wherein the computing system generates the forecast of needed vegetation maintenance based on the site-anomaly data.

9. The network-based system as defined in claim 1, wherein the computing system generates the schedule for performing future vegetation maintenance events so as to prioritize performances of the future maintenance events based on a predefined set of criteria.

10. The network-based system as defined in claim 1, wherein the computing system further generates a set of work assignments based upon the schedule generated and the plurality of site-specific vegetation indicators received.

11. The network-based system as defined in claim 10, wherein a work assignment for a particular site is based upon at least one of a type of work to be performed at the site, a type of equipment needed to perform the work assignment, and a predetermined time period in which to perform the work assignment.

12. The network-based system as defined in claim 10, wherein the work assignments are conveyed over the data communications network to at least one contractor contracted to perform.

13. The network-based system as defined in claim 12, wherein the computing system receives work performance data based upon performances of the work assignments and generates post-performance evaluations of the work performed.

14. The network-based system as defined in claim 13, wherein the computing system generates invoices and associated billing records based on the post-performance evaluations.

15. The network-based system as defined in claim 13, wherein the computing system maintains an updatable list of contractors for performing future work assignments, the list of contractors being intermittently updated based upon at least one post-performance evaluation.

16. The network-based system as defined in claim 1, wherein the at least one data communications device has the capability for wirelessly communicating with the data communications network.

17. The network-based system as defined in claim 16, wherein the at least one data communications device comprises a mobile device.

18. A computer-based system for managing vegetation maintenance at a plurality of sites, the computer-based system comprising:
a memory for storing a plurality of site-specific vegetation indicators, the vegetation indicators indicating vegetation conditions at a plurality of predetermined sites;
a forecasting module for generating a forecast of vegetation conditions for the plurality of sites based upon the plurality of site-specific vegetation indicators; and
a scheduling module for generating a schedule for performing future vegetation maintenance events within a predefined time period based on the forecast of needed vegetation maintenance.

19. A computer-based system as defined in claim 18, further comprising a performance monitoring module for generating post-event vegetation maintenance reports based upon performance indicia received after performances of vegetation maintenance events at the plurality of sites.

20. The computer-based system as defined in claim 18, wherein the forecast generated by the forecast module comprises a forecast of a time when at least one unit of vegetation is within a predefined tolerance for a corresponding unit of infrastructure.

21. The network-based system as defined in claim 18, wherein the forecast generated by the forecast module is based upon at least one factor-adjusted growth rate for at least one vegetation unit, the growth rate being adjustable based upon at least one of a vegetation competition factor, a climatic profile factor, and a micro climate factor.

22. The computer-based system as defined in claim 18, wherein the site-specific vegetation indicators include past performance data representing past performances of vegetation maintenance events, and wherein the forecasting module generates the forecast of needed vegetation maintenance based on the stored past performance data.

23. The computer-based system as defined in claim 18, wherein the site-specific vegetation indicators include past expenditure data representing past expenditures for performing vegetation maintenance events, and wherein the forecasting module generates the forecast of needed vegetation maintenance based on the past expenditure data.

24. The computer-based system as defined in claim 18, wherein the site-specific vegetation indicators include site-anomaly data indicative of vegetation anomalies for at least one of the plurality of sites, and wherein the forecasting module generates the forecast of needed vegetation maintenance based on the site-anomaly data.

25. The computer-based system as defined in claim 18, wherein the site-specific vegetation indicators include a site-specific vegetation inventory for each of the plurality of sites, and wherein the forecasting module generates the forecast of needed vegetation maintenance based on the site-anomaly data.

26. The computer-based system as defined in claim 18, wherein the scheduling module generates the schedule for performing future vegetation maintenance events so as to prioritize performances of the future maintenance events based on a predefined set of criteria.

27. The computer-based system as defined in claim 18, further comprising a work assigning module for generating a set of work assignments based upon the schedule generated and the plurality of site-specific vegetation indicators received.

28. The computer-based system as defined in claim 27, wherein a work assignment for a particular site is based upon at least one of a type of work to be performed at the site, a type of equipment needed to perform the work assignment, and a predetermined time period in which to perform the work assignment.

29. The computer-based system as defined in claim 27, wherein the work assigning module receives work performance data based upon performances of the work assignments and generates post-performance evaluations of the work performed.

30. The computer-based system as defined in claim 29, wherein the work assigning module generates invoices and associated billing records based on the post-performance evaluations.

31. The computer-based system as defined in claim 29, wherein the work assigning module generates an updatable list of contractors for performing future work assignments, the list of contractors being intermittently updated based upon at least one post-performance evaluation.

32. A method for handling vegetation maintenance at a plurality of sites, the method comprising:
obtaining site-specific vegetation maintenance indicia;
scheduling a plurality of vegetation maintenance events to occur within a predetermined time period at a plurality of predetermined sites;
performing a plurality of vegetation maintenance events in accordance with the scheduling of the plurality of vegetation maintenance events; and
auditing the performing of the plurality of vegetation maintenance events to determine a measure of performance achievement.

33. A machine-readable medium comprising computer instructions for:
storing in a database a plurality of site-specific vegetation indicators for a plurality of sites;
generating a forecast of vegetation conditions for the plurality of sites based upon the plurality of site-specific vegetation indicators; and
generating a schedule for performing future vegetation maintenance events within a predefined time period based on the forecast of needed vegetation maintenance.

34. A machine-readable medium as defined in claim 33, further comprising at least one computer instruction for generating post-event vegetation maintenance reports based upon performance indicia received after performances of vegetation maintenance events at the plurality of sites.

35. The machine-readable medium as defined in claim 33, wherein the forecast generated based upon the computer instructions comprises a forecast of a time when at least one unit of vegetation is within a predefined tolerance for a corresponding unit of infrastructure.

36. The machine-readable medium as defined in claim 33, wherein the forecast generated based upon the computer instructions is based upon at least one factor-adjusted growth rate for at least one vegetation unit, the growth rate being adjustable based upon at least one of a vegetation competition factor, a climatic profile factor, and a micro climate factor.

37. The machine-readable code of claim 33, further comprising at least one computer instruction for generating a set of work assignments based upon the schedule generated and the plurality of site-specific vegetation indicators received.

38. The machine-readable medium as defined in claim 37, wherein a work assignment for a particular site is based upon at least one of a type of work to be performed at the site, a type of equipment needed to perform the work assignment, and a predetermined time period in which to perform the work assignment.

39. The machine-readable medium as defined in claim 37, further comprising at least one computer instruction for generating post-performance evaluations of the work performed based on work performance data.

40. The machine-readable medium as defined in claim 39, further comprising at least one computer instruction for generating invoices and associated billing records based on the post-performance evaluations.

41. The machine-readable medium as defined in claim 39, further comprising at least one computer instruction for generating an updatable list of contractors for performing future work assignments, the list of contractors being intermittently updated based upon at least one post-performance evaluation.
